(19) United States
(12) Patent Application Publication
(10) Pub. No.: US 2013/0093209 A1
(43) Pub. Date: Apr. 18, 2013

(54) AUTOMOTIVE VEHICLES WITH FRONT TIRE PROTECTORS

(71) Applicant: DONNELL B. JOHNSON, WARREN, MI (US)

(72) Inventor: DONNELL B. JOHNSON, WARREN, MI (US)

(73) Assignee: GM GLOBAL TECHNOLOGY OPERATIONS LLC, DETROIT, MI (US)

(21) Appl. No.: 13/276,190

(22) Filed: Oct. 18, 2011

(51) Int. Cl. B62D 35/00

(52) U.S. Cl. 296/180.1

(57) ABSTRACT

An automotive vehicle includes a body, a drive system, a plurality of wheels, a plurality of tires, and a plurality of protrusions. The body has a centerline and a front portion. The front portion comprises a front surface comprising a driver's side front surface and a passenger's side front surface. The drive system is disposed within the body. The wheels are coupled to the drive system, and include front wheels. Each of the tires is mounted on a respective wheel. The tires include front tires mounted on the front wheels. The protrusions extend outward from the front surface for protection of the front tires. The protrusions include a first pair of protrusions and a second pair of protrusions. The first pair of protrusions extend outward from the driver's side front surface. The second pair of protrusions extend outward from the passenger's side front surface.

### TECHNICAL FIELD

The present disclosure generally relates to the field of automotive vehicles and, more specifically, to automotive vehicles with front tire protectors.

### BACKGROUND

Automotive vehicles generally encounter aerodynamic resistance, or drag, as the automotive vehicle is operated. One type of aerodynamic resistance in automotive vehicles occurs when relatively high velocity air makes contact with front tires of the automotive vehicle during operation of the automotive vehicle. Today's automotive vehicles may not provide optimal protection against aerodynamic drag during operation of the automotive vehicle.

Accordingly, it is desirable to provide automotive vehicles with improved protection against aerodynamic drag. Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, an automotive vehicle is provided. The automotive vehicle comprises a body, a drive system, a plurality of wheels, a plurality of tires, and a plurality of protrusions. The body has a centerline and a front portion. The front portion comprises a front surface comprising a driver's side front surface and a passenger's side front surface. The driver's side front surface is disposed on a driver's side of the automotive vehicle. The passenger's side front surface is disposed on a passenger's side of the automotive vehicle. The drive system is disposed within the body. The plurality of wheels are coupled to the drive system, and include a plurality of front wheels. Each of the plurality of tires is mounted on a respective one of the plurality of wheels. The plurality of tires include a plurality of front tires mounted on the plurality of front wheels. The plurality of protrusions extend outward from the front surface for protection of the plurality of front tires. The plurality of protrusions comprise a first pair of protrusions and a second pair of protrusions. The first pair of protrusions extend outward from the driver's side front surface. The second pair of protrusions extend outward from the passenger's side front surface.

In accordance with another exemplary embodiment, an automotive vehicle is provided. The automotive vehicle comprises a body, a drive system, a plurality of wheels, a plurality of tires, an airdam, and a plurality of protrusions. The body has a centerline and a front portion. The front portion comprises a front surface. The drive system is disposed within the body. The plurality of wheels are coupled to the drive system, and include a plurality of front wheels. Each of the plurality of tires is mounted on a respective one of the plurality of wheels. The plurality of tires include a plurality of front tires mounted on the plurality of front wheels. The airdam is disposed against the front surface. The airdam has an airdam surface comprising a driver's side airdam surface on a driver's side of the automotive vehicle and a passenger's side airdam surface on a passenger's side of the automotive vehicle. The plurality of protrusions extend outward from the airdam surface for protection of the plurality of front tires. The plurality of protrusions comprise a firs pair of protrusions and a second pair of protrusions. The first pair of protrusions extend outward from the driver's side airdam surface. The second pair of protrusions extend outward from the passenger's side airdam surface.

In accordance with a further exemplary embodiment, an automotive vehicle is provided. The automotive vehicle comprises a body, a drive system, a plurality of wheels, a plurality of tires, a bumper, and a plurality of protrusions. The body has a centerline and a front portion. The front portion comprises a front surface. The drive system is disposed within the body. The plurality of wheels are coupled to the drive system, and include a plurality of front wheels. Each of the plurality of tires is mounted on a respective one of the plurality of wheels. The plurality of tires include a plurality of front tires mounted on the plurality of front wheels. The bumper is disposed against the front surface. The bumper has a bumper surface comprising a driver's side bumper surface on a driver's side of the automotive vehicle and a passenger's side bumper surface on a passenger's side of the automotive vehicle. The plurality of protrusions extend outward from the bumper surface for protection of the plurality of front tires. The plurality of protrusions comprise a firs pair of protrusions and a second pair of protrusions. The first pair of protrusions extend outward from the driver's side bumper surface. The second pair of protrusions extend outward from the passenger's side bumper surface.

### BRIEF DESCRIPTION OF THE DRAWINGS

The present disclosure will hereinafter be described in conjunction with the following drawing figures, wherein like numerals denote like elements, and wherein:

FIG. 1 is a plan view of an automotive vehicle having front tires and a front surface that includes two pairs of protrusions, one on the driver's side and one on the passenger's side of the automotive vehicle, for protection of the front tires, in accordance with an exemplary embodiment;

FIG. 2 is a close-up, plan view of a portion of the automotive vehicle of FIG. 1, including an airdam and two pairs of protrusions extending from the airdam, one on the driver's side and one on the passenger's side of a surface of the airdam, for protection of the front tires, in accordance with an exemplary embodiment; and

FIG. 3 is a close-up, plan view of a portion of the automotive vehicle of FIG. 1, including a front bumper and two pairs of protrusions extending from the front bumper, one on the driver's side and one on the passenger's side of a surface of the front bumper, for protection of the front tires, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

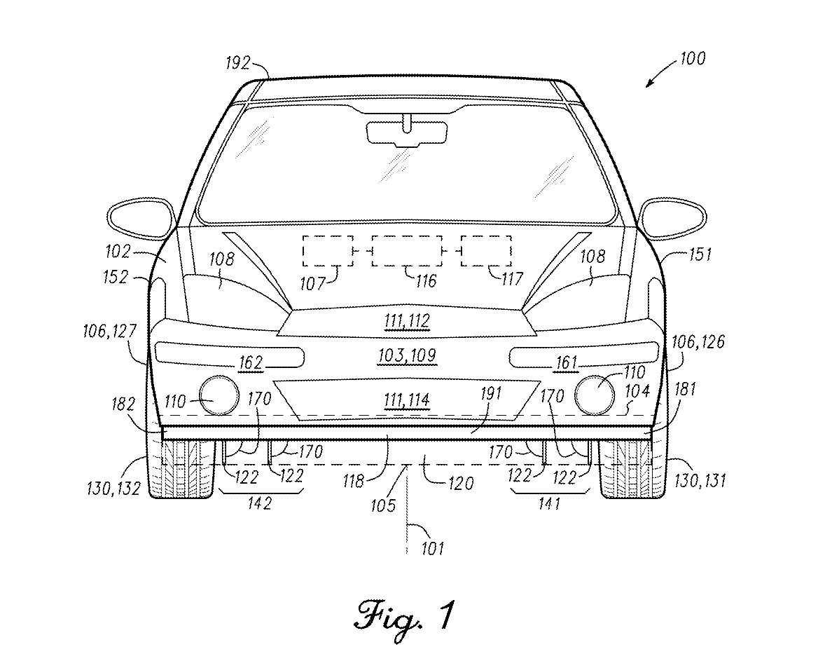

FIG. 1 illustrates an automotive vehicle 100, or automobile, according to an exemplary embodiment. The automotive vehicle 100 includes a body 102 that is arranged on a chassis 104. The body 102 substantially encloses the other components of the automotive vehicle 100. The body 102 and the chassis 104 may jointly form a frame. The body 102 forms, among other regions, a front portion 103 comprising a front surface 109, and an undercarriage 105. As described in greater detail further below, the automotive vehicle 100 further includes front tires 131, 132 that are at least partially protected from high velocity air by two pairs of protrusions 122 extending perpendicular, or normal, to the front surface 109 proximate the front tires 131, 132.

In FIG. 1, the automotive vehicle 100 is shown from a view directly in front of the automotive vehicle 100. The automotive vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD).

As used herein, the front surface 109 refers to a surface of the front portion 103 of the automotive vehicle body 102 that is facing in a forward direction of travel of the automotive vehicle 100. The front surface 109 includes a driver's side front surface 161 proximate a driver's side 151 of the automotive vehicle 100. The front surface 109 includes a passenger's side front surface 162 proximate a passenger's side 152 of the automotive vehicle 100. Also as used herein, the undercarriage 105 refers to a bottom portion of the automotive vehicle 100 formed by the body 102, facing the road, that is disposed beneath the occupancy regions within the automotive vehicle 100 in which a driver and passengers of the automotive vehicle 100 may be seated, and also below a trunk of the automotive vehicle 100, an engine compartment of the automotive vehicle 100, and/or other inner regions within the automotive vehicle 100 in which various other components of the automotive vehicle 100 may be housed.

As depicted in FIG. 1, the automotive vehicle 100 also includes a plurality of wheels 106, a plurality of tires 130, a drive system 107, front headlights 108, front fog lights 110, front surface openings 111, a radiator 116, an environmental control system 117, and a front bumper 118, in addition to the above-referenced protrusions 122.

The wheels 106 are each rotationally coupled to the chassis 104 near a respective corner of the body 102 to facilitate movement of the automotive vehicle 100. In a preferred embodiment, the automotive vehicle 100 includes four wheels 106, although this may vary in other embodiments (for example for trucks and certain other automotive vehicles). The wheels 106 preferably include a plurality of rear wheels (not depicted), as well as a plurality of front wheels that include a first front wheel 126 and a second front wheel 127. The first front wheel 126 is disposed proximate the driver's side 151, and the second front wheel 127 is disposed proximate the passenger's side 152 of the automotive vehicle 100.

Each of the tires 130 are mounted on a respective one of the wheels 106. In a preferred embodiment, the automotive vehicle 100 includes four tires 130, although this may vary in other embodiments (for example for trucks and certain other automotive vehicles in which the number of wheels 106 is less than or greater than four). The tires 130 preferably include a plurality of rear tires (not depicted) that are mounted on respective rear wheels, as well as a plurality of front tires that are mounted on respective front wheels. The front tires include a first front tire 131 that is mounted on the first front wheel 126 and a second front tire 132 that is mounted on the second front wheel 127.

The drive system 107 is mounted on the chassis 104, and drives the wheels 106. The drive system 107 preferably comprises a propulsion system. In certain exemplary embodiments, the drive system 107 comprises a combustion engine and/or an electric motor/generator, coupled with a transmission thereof. In certain embodiments, the drive system 107 may vary, and/or two or more drive systems 107 may be used. By way of example, the automotive vehicle 100 may also incorporate any one of, or combination of, a number of different types of electrical propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

The front fog lights 110 are depicted in FIG. 1 as being disposed approximately directly below the front headlights 108. However, this may vary in other embodiments. Regardless, as depicted in FIG. 1, the automotive vehicle 100 preferably includes two front headlights 108 and two front fog lights 110 along the front surface 109.

The front surface openings 111 are formed in the front surface 109 of the automotive vehicle 100. In the depicted embodiment, the front surface openings 111 include an upper front opening 112 and a lower front opening 114. The upper front opening 112 comprises an upper grille, and the lower front opening 114 comprises a lower grille. The number of openings 111 and/or their configuration may vary in other embodiments. For example, in one exemplary embodiment, the automotive vehicle 100 may include a single front grille. In another exemplary embodiment, the automotive vehicle 100 may include three or more front grilles.

The radiator 116 receives air from outside the automotive vehicle 100 via the opening(s) 111. In one embodiment, the radiator 116 is connected to the frame at an outer portion thereof and, although not illustrated in detail, includes multiple cooling channels therein that contain a cooling fluid (i.e., coolant) such as water and/or ethylene glycol (i.e., “antifreeze”), and is coupled to the drive system 107 and the environmental control system 117.

The environmental control system 117 is coupled to the radiator 116, and uses the outside air for cooling the automotive vehicle 100. In a preferred embodiment, the environmental control system 117 comprises an air conditioning system for the automotive vehicle 100. The outside air may also be used for cooling the drive system 107 and/or components thereof (such as a combustion engine) and/or other components of the automotive vehicle 100.

The front bumper 118 is disposed against the front surface 109 of the automotive vehicle 100 in a lower region of the front surface 109. In a preferred embodiment, the front bumper 118 is made of a plastic material. The front bumper 118 is preferably attached to the front surface 109 via an adhesive material during manufacturing of the automotive vehicle 100.

In certain embodiments, an airdam 120 is disposed against the front surface 109. The airdam 120 is depicted in phantom in FIG. 1. In a preferred embodiment, the airdam 120 is also made of a plastic material. In certain embodiments, the airdam 120 may comprise a metallic material. The airdam 120, if utilized, is preferably positioned directly below the front bumper 118. The airdam 120 helps to provide protection for the front tires 131, 132 from high velocity air.

The automotive vehicle 100 also includes the above-referenced pairs of protrusions 122. In the depicted embodiment, the automotive vehicle 100 includes a first pair 141 of protrusions 122 and a second pair 142 of protrusions 122. Each of the protrusions 122 extends, from and is perpendicular, or normal to, the front surface 109. In certain embodiments, three or more such pairs of protrusions 122 may be used.

As depicted in FIG. 1, the pairs 141, 142 of protrusions 122 are positioned on, and extend from, opposite sides of the front surface 109. Specifically, in the illustrated embodiment, the first pair 141 of protrusions 122 are positioned on, extend from, and are perpendicular (or normal) to the driver's side front surface 161 on the driver's side 151. The second pair 142 of protrusions 122 are positioned on, extend from, and are perpendicular (or normal) to the passenger's side front surface 162 on the passenger's side 152 of the automotive vehicle 100.

In a preferred embodiment, each of the pairs 141, 142 of protrusions 122 are positioned on (and extend from) a lower corner of the respective front surface 161, 162. The first pair 141 of protrusions 122 are disposed proximate the first front tire 131, and approximately directly below the fog light 110 on the driver's side 151 of the automotive vehicle 100. The second pair 142 of protrusions 122 are disposed proximate the second front tire 132, and approximately directly below the fog light 110 on the passenger's side 152 of the automotive vehicle 100.

Each of the protrusions 122 within a particular pair are disposed approximately six inches to twelve inches from one another. Specifically, the two protrusions 122 of the first pair 141 are spaced approximately six inches to twelve inches from one another. Similarly, the two protrusions 122 of the second pair 142 are spaced approximately six inches to twelve inches from one another.

Each of the protrusions 122 is preferably disposed substantially perpendicular to the front surface 109, and substantially perpendicular to the front bumper 118. Specifically, each protrusion 122 forms an angle 170 with respect to the front surface 109 that is preferably at least substantially equal to, and that is most preferably equal to, ninety degrees. Phrased another way, each of the protrusions 122 preferably extends in a forward direction of travel of the automotive vehicle 100, and that is parallel to a direction from a rear portion 192 of the automotive vehicle 100 to a front portion 191 of the automotive vehicle 100.

The pairs 141, 142, of protrusions 122 provide protection for the front tires 131, 132 from high velocity, outside air during operation of the automotive vehicle 100. Specifically, the pairs 141, 142 of protrusions 122 serve as deflectors to shield the front tires 131, 132 (in addition to lower control arms and/or other non-depicted chassis 104 components) from high velocity, outside air. In addition, the pairs 141, 142 of protrusions 122 direct the high velocity, outside air down and around the front tires 131, 132. The pairs 141, 142 of protrusions 122 further slow and compress the high velocity, outside air near the front tires 131, 132 to further reduce exposure of the front tires 131, 132 to the high velocity air. As a result, the pairs 141, 142 of protrusions provide for potential improvements for fuel economy for the automotive vehicle 100.

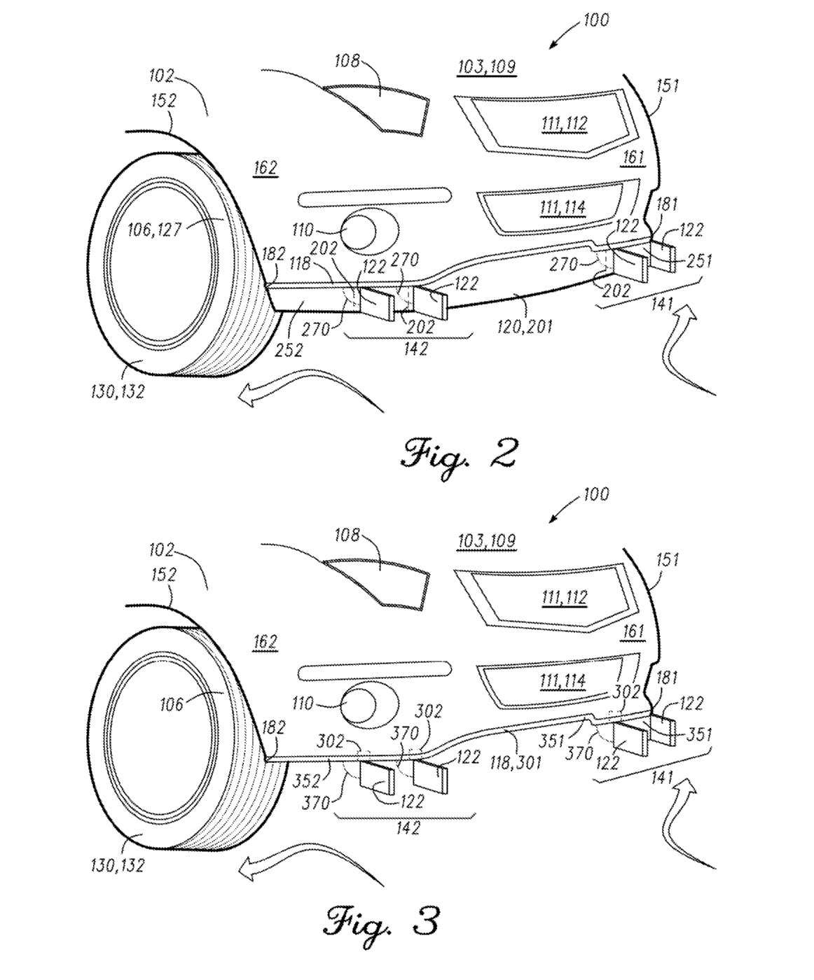

Depending on the embodiment, the protrusions 122 may extend from the airdam 120 (as described directly below in connection with the embodiment of FIG. 2) or, alternatively, from the bumper 118 (as described further below in connection with the embodiment of FIG. 3) of the front surface 109. In either case, the protrusions 122 provide protection for the front tires 131, 132 from high velocity air during operation of the automotive vehicle 100.

Specifically, FIG. 2 is a close-up, plan view of a portion of the automotive vehicle 100 of FIG. 1, in accordance with an embodiment in which the automotive vehicle 100 includes an airdam 120. The airdam 120 is disposed against the front surface 109 of the automotive vehicle 100. In one such embodiment, the airdam 120 is molded into the front surface 109 during manufacturing of the automotive vehicle 100. In another such embodiment, the airdam 120 comprises a separate piece that is fastened (for example, via screws) to the front surface 109 during manufacturing of the automotive vehicle 100.

As depicted in FIG. 2, the airdam 120 has an airdam surface 201 facing outward and away from the automotive vehicle 100. The airdam surface 201 has a driver's side airdam surface 251 and a passenger's side airdam surface 252. The driver's side airdam surface 251 is disposed on the driver's side 151, proximate the outer edge 181 thereof and the driver's side front surface 161. The passenger's side airdam surface 252 is disposed on the passenger's side 152, proximate the outer edge 182 thereof and the passenger's side front surface 162.

In the embodiment of FIG. 2, each of the protrusions 122 extends outward from, and is normal, or perpendicular to, the airdam surface 201. Each of the protrusions 122 forms an angle 270 with respect to the airdam surface 201. The angle 270 is preferably equal to ninety degrees. Specifically, each of the first pair 141 of protrusions 122 extends outward from, and is normal, or perpendicular to, the driver's side airdam surface 251, and forms a ninety degree angle with respect to the driver's side airdam surface 251. Similarly, each of the second pair 142 of protrusions 122 extends outward from, and is normal, or perpendicular to, the passenger's side airdam surface 252, and forms a ninety degree angle with respect to the passenger's side airdam surface 252.

Also in the embodiment of FIG. 2, each of the protrusions 122 preferably comprises the same material (or a similar material) as the airdam 120. In one such example, the protrusions 122 comprise a plastic material. In another such exemplar, the protrusions 122 comprise a metallic material.

In addition, in the embodiment of FIG. 2, a base 202 (depicted in phantom in FIG. 2) is provided for each of the protrusions 122. Specifically, in one example of the embodiment of FIG. 2, the base 202 for each protrusion 122 is positioned between the respective protrusion 122 and the airdam surface 201. The bases 202 can be used as a mounting platform for mounting the protrusions 122 against the airdam 120, for example via a screw assembly (not depicted). The bases 202 are preferably made from the same material as the protrusions 122, most preferably from a plastic or metal material. In certain embodiments, bases 202 are not needed for the protrusions 122. For example, in certain embodiments, the protrusions 122 may be molded as part of the airdam 120 as a single, integral piece with the airdam 120.

In one example of the embodiment of FIG. 2, each protrusion 122 has a length of approximately three to four inches (extending from the airdam surface 201 away from the automotive vehicle 100), a width of approximately two inches, and a depth of approximately one-eighth of an inch. Each base 202 preferably has a length of approximately one inch (extending from the airdam surface 201 away from the automotive vehicle 100), a width of approximately one inch, and a depth of approximately one-eighth of an inch.

With reference to FIG. 3, a close-up, plan view is provided of a portion of the automotive vehicle 100 of FIG. 1, in accordance with an alternate embodiment in which the automotive vehicle 100 does not include an airdam. In the embodiment of FIG. 3, the bumper 118 of FIG. 1 includes a bumper surface 301 facing outward and away from the automotive vehicle 100. The bumper surface 301 has a driver's side bumper surface 351 and a passenger's side bumper surface 352. The driver's side bumper surface 351 is disposed on the driver's side 151, proximate the outer edge 181 thereof and the driver's side front surface 161. The passenger's side bumper surface 352 is disposed on the passenger's side 152, proximate the outer edge 182 thereof and the passenger's side front surface 162.

In the embodiment of FIG. 3, each of the protrusions 122 extends outward from, and is normal, or perpendicular to, the bumper surface 301. Each of the protrusions 122 forms an angle 370 with respect to the bumper surface 301. The angle 370 is preferably equal to ninety degrees. Specifically, each of the first pair 141 of protrusions 122 extends outward from, and is normal, or perpendicular to, the driver's side bumper surface 351, and forms a ninety degree angle with respect to the driver's side bumper surface 351. Similarly, each of the second pair 142 of protrusions 122 extends outward from, and is normal, or perpendicular to, the passenger's side bumper surface 352, and forms a ninety degree angle with respect to the passenger's side bumper surface 352.

Also in the embodiment of FIG. 3, each of the protrusions 122 preferably comprise the same material as the bumper 118, most preferably a plastic material, but may also comprise a metallic material. In addition, in one example, a base 302 (depicted in phantom in FIG. 3) is provided for each of the protrusions 122. Specifically, in one example of the embodiment of FIG. 3, the base 302 for each protrusion 122 is positioned between the respective protrusion 122 and the bumper surface 301. The bases 302 can be used as a mounting platform for mounting the protrusions 122 against the bumper 118, for example via a screw assembly (not depicted). The bases 302 are preferably made from the same material as the protrusions 122, most preferably from a plastic or metal material. In certain embodiments, bases 302 are not needed for the protrusions 122. For example, in certain embodiments, the protrusions 122 may be molded as part of the bumper 118 as a single, integral piece with the bumper 118.

In one example of the embodiment of FIG. 3, each protrusion 122 has a length of approximately three to four inches (extending from the bumper surface 301 away from the automotive vehicle 100), a width of approximately two inches, and a depth of approximately one-eighth of an inch. Each base 302 preferably has a length of approximately one inch (extending from the bumper surface 301 away from the automotive vehicle 100), a width of approximately one inch, and a depth of approximately one-eighth of an inch.

The pairs 141, 142 of protrusions 122 of FIGS. 1-3 help to shield the front tires 131, 132 (in addition to lower control arms and/or other non-depicted chassis 104 components) from high velocity air. In addition, the pairs 141, 142 of protrusions 122 direct the high velocity, outside air down and around the front tires 131, 132. The pairs 141, 142 of protrusions 122 further slow and compress the high velocity, outside air near the front tires 131, 132 to further reduce exposure of the front tires 131, 132 to the high velocity air. As a result, the pairs 141, 142 of protrusions provide for potential improvements for fuel economy for the automotive vehicle 100.

Accordingly, improved vehicles are provided. The disclosed vehicles include pairs of protrusions that extend from a front surface of the automotive vehicle and that are positioned on a driver's side and a passenger's side of the front surface in a manner that helps to protect the tires from high velocity air. This in turn can help to reduce aerodynamic resistance, or drag, for the automotive vehicle.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. An automotive vehicle comprising:
a body having a centerline and a front portion, the front portion comprising a front surface comprising a driver's side front surface on a driver's side of the automotive vehicle and a passenger's side front surface on a passenger's side of the automotive vehicle;
a drive system disposed within the body;
a plurality of wheels coupled to the drive system, the plurality of wheels including a plurality of front wheels;
a plurality of tires, each of the plurality of tires mounted on a respective one of the plurality of wheels, the plurality of tires including a plurality of front tires mounted on the plurality of front wheels; and
a plurality of protrusions extending outward from the front surface for protection of the plurality of front tires, the plurality of protrusions comprising:
a first pair of protrusions extending outward from the driver's side front surface; and
a second pair of protrusions extending outward from the passenger's side front surface.

2. The automotive vehicle of claim 1, wherein:
the plurality of front wheels comprises:
a first front wheel disposed on the driver's side of the automotive vehicle; and
a second front wheel disposed on the passenger's side of the automotive vehicle;
the plurality of front tires comprises:
a first front tire mounted on the first front wheel; and
a second front tire mounted on the second front wheel;
the first pair of protrusions is disposed proximate the first front tire; and
the second pair of protrusions is disposed proximate the second front tire.

3. The automotive vehicle of claim 1, wherein:
the plurality of front wheels comprises:
a first front wheel disposed on the driver's side of the automotive vehicle; and
a second front wheel disposed on the passenger's side of the automotive vehicle;
the plurality of front tires comprises:
a first front tire mounted on the first front wheel; and
a second front tire mounted on the second front wheel;
the first pair of protrusions is configured to direct air away from the first front tire; and
the second pair of protrusions is configured to direct air away from the second front tire.

4. The automotive vehicle of claim 1, wherein each of the plurality of protrusions is disposed normal to the front surface.

5. The automotive vehicle of claim 1, wherein each of the plurality of protrusions extends from the front surface in a forward direction of travel of the automotive vehicle.

6. The automotive vehicle of claim 1, wherein each of the plurality of protrusions forms an approximately ninety degree angle with respect to the front surface.

7. The automotive vehicle of claim 1, further comprising:
an airdam disposed against the front surface;
wherein the plurality of protrusions extend from the airdam.

8. The automotive vehicle of claim 1, further comprising:
a bumper disposed against the front surface;
wherein the plurality of protrusions extend from the bumper.

9. An automotive vehicle comprising:
a body having a centerline and a front portion, the front portion comprising a front surface;
a drive system disposed within the body;
a plurality of wheels coupled to the drive system, the plurality of wheels including a plurality of front wheels;
a plurality of tires, each of the plurality of tires mounted on a respective one of the plurality of wheels, the plurality of tires including a plurality of front tires mounted on the plurality of front wheels;
an airdam disposed against the front surface, the airdam having an airdam surface comprising a driver's side airdam surface on a driver's side of the automotive vehicle and a passenger's side airdam surface on a passenger's side of the automotive vehicle; and
a plurality of protrusions extending outward from the airdam surface for protection of the plurality of front tires, the plurality of protrusions comprising:
a first pair of protrusions extending outward from the driver's side airdam surface; and
a second pair of protrusions extending outward from the passenger's side airdam surface.

10. The automotive vehicle of claim 9, wherein:
the plurality of front wheels comprises:
a first front wheel disposed on the driver's side of the automotive vehicle; and
a second front wheel disposed on the passenger's side of the automotive vehicle;
the plurality of front tires comprises:
a first front tire mounted on the first front wheel; and
a second front tire mounted on the second front wheel;
the first pair of protrusions is disposed proximate the first front wheel; and
the second pair of protrusions is disposed proximate the second front wheel.

11. The automotive vehicle of claim 9, wherein:
the plurality of front wheels comprises:
a first front wheel disposed on the driver's side of the automotive vehicle; and
a second front wheel disposed on the passenger's side of the automotive vehicle;
the plurality of front tires comprises:
a first front tire mounted on the first front wheel; and
a second front tire mounted on the second front wheel;
the first pair of protrusions is configured to direct air away from the first front wheel; and
the second pair of protrusions is configured to direct air away from the second front wheel.

12. The automotive vehicle of claim 9, wherein each of the plurality of protrusions is disposed normal to the airdam surface.

13. The automotive vehicle of claim 9, wherein each of the plurality of protrusions extends from the airdam surface in a forward direction of travel of the automotive vehicle.

14. The automotive vehicle of claim 9, wherein each of the plurality of protrusions forms an approximately ninety degree angle with respect to the airdam surface.

15. An automotive vehicle comprising:
a body having a centerline and a front portion, the front portion comprising a front surface;
a drive system disposed within the body;
a plurality of wheels coupled to the drive system, the plurality of wheels including a plurality of front wheels;
a plurality of tires, each of the plurality of tires mounted on a respective one of the plurality of wheels, the plurality of tires including a plurality of front tires mounted on the plurality of front wheels;
a bumper disposed against the front surface, the bumper having a bumper surface comprising a driver's side bumper surface on a driver's side of the automotive vehicle and a passenger's side bumper surface on a passenger's side of the automotive vehicle; and
a plurality of protrusions extending outward from the bumper surface for protection of the plurality of front tires, the plurality of protrusions comprising:
a first pair of protrusions extending outward from the driver's side bumper surface; and
a second pair of protrusions extending outward from the passenger's side bumper surface.

16. The automotive vehicle of claim 15, wherein:
the plurality of front wheels comprises:
a first front wheel disposed on the driver's side of the automotive vehicle; and
a second front wheel disposed on the passenger's side of the automotive vehicle;
the plurality of front tires comprises:
a first front tire mounted on the first front wheel; and
a second front tire mounted on the second front wheel;
the first pair of protrusions is disposed proximate the first front wheel; and
the second pair of protrusions is disposed proximate the second front wheel.

17. The automotive vehicle of claim 15, wherein:
the plurality of front wheels comprises:
a first front wheel disposed on the driver's side of the automotive vehicle; and
a second front wheel disposed on the passenger's side of the automotive vehicle;
the plurality of front tires comprises:
a first front tire mounted on the first front wheel; and
a second front tire mounted on the second front wheel;
the first pair of protrusions is configured to direct air away from the first front wheel; and
the second pair of protrusions is configured to direct air away from the second front wheel.

18. The automotive vehicle of claim 15, wherein each of the plurality of protrusions is disposed normal to the bumper surface.

19. The automotive vehicle of claim 15, wherein each of the plurality of protrusions extends from the bumper surface in a forward direction of travel of the automotive vehicle.

20. The automotive vehicle of claim 15, wherein each of the plurality of protrusions forms an approximately ninety degree angle with respect to the bumper surface.
